(19) United States
(12) Patent Application Publication
(10) Pub. No.: US 2007/0063085 A1
(43) Pub. Date: Mar. 22, 2007

(54) Reel, recording tape cartridge, metal mold and method for molding reel

(75) Inventors: Katsuki Asano, Kanagawa (JP); Ren Ishikawa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/517,349

(22) Filed: Sep. 8, 2006

(30) Foreign Application Priority Data
Sep. 15, 2005 (JP) 2005-269190

(51) Int. Cl. G03B 23/02

(52) U.S. Cl. 242/348

(57) ABSTRACT

In a metal mold, a part of a portion corresponding to a reel gear in a bottom portion side of a hub is divided, and a gate port of a resin is provided in this portion. A flow path of the resin to the gate port is inclined in a peripheral direction with respect to an axial direction of the hub. The resin is guided by the flow path. In the hub, an orientation of the resin (a flow of the resin) is inclined in the peripheral direction with respect to the axis of the hub, and in a lower flange, the orientation of the resin is inclined with respect to a direction of a radial line of the lower flange.

### CROSS-REFERENCE TO RELATED APPLICATION

This application claims priority under 35 USC 119 from Japanese Patent Application No. 2005-269190, the disclosure of which is incorporated by reference herein.

### BACKGROUND OF THE INVENTION

1. Field of the Invention

The present invention relates to a reel winding a recording tape such as a magnetic tape or the like therearound, a recording tape cartridge, a metal mold and a method for molding the reel.

2. Description of the Related Art

As external storage media for computers and the like, recording tape cartridges are known which house a reel wound with magnetic tape inside a case. The reel includes a hub, which configures the axial center portion of the recording tape cartridge and on whose outer periphery the magnetic tape is wound, and an upper flange and a lower flange, which protrude outward in the radial direction from both axial line-direction ends of the hub.

Recording tape cartridges are also known where recording tape such as magnetic tape is wound onto a single reel and which rotatably house the reel inside a case made of synthetic resin. A leader member, such as a leader pin, a leader tape, or a leader block, is disposed on the leading end of the recording tape. Pullout means disposed in a drive device pull out the leader member through an opening in the recording tape cartridge, and the recording tape fixed to the leader member is wound onto a take-up reel of the drive device.

In the reels of such recording tape cartridges, the recording tape is ordinarily wound onto the outer peripheral surface of the hub. The upper flange and the lower flange are disposed above and below the hub, and the position of the recording tape in the vertical direction when the recording tape is wound is regulated by the upper and lower flanges, whereby the recording tape is retained such that the winding is good, the traveling stability of the recording tape is improved, and damage to the recording tape from the outside is prevented when the recording tape is not in use.

However, because the hub is molded with resin, sometimes, as shown in FIG. 8, the substantially central portion of a hub 100 becomes bent inward due to constriction caused by the recording tape being tightly wound onto the hub 100. Additionally, in accompaniment therewith, the distance between an upper flange 102 and a lower flange 104 disposed on both end portions of the hub 100 gradually becomes narrower toward the outer peripheries of the upper flange 102 and the lower flange 104, and there is the potential for the edge portions of the recording tape (not shown) to sustain damage.

Accordingly, for example, as shown in Japanese Patent Application Laid-Open (JP-A) Nos. 2004-14022 and 2004-14023, there can be considered a structure in which a hub is reinforced by a metal ring-shaped member in order to prevent the hub from being deformed, however, a manufacturing cost is increased.

### SUMMARY OF THE INVENTION

The invention is made by taking the fact mentioned above into consideration, and inexpensively obtains a reel in which a deformation due to a winding pressure or the like of a magnetic tape is made small, a recording tape cartridge and a metal mold.

In accordance with a first aspect of the invention, there is provided a reel comprising a hub around which a recording tape is wound, and flanges provided at both end portions of the hub and holding an end portion of the recording tape in a width direction thereof. A flow path of a resin molding a hub to a gate port is inclined in a peripheral direction with respect to an axis of the hub.

It is possible to incline an orientation of the resin (a flow of the resin) at a time of molding the hub in the peripheral direction with respect to the axis of the hub, by inclining the flow path (a so-called runner) of the resin to the gate port in the peripheral direction with respect to the axis of the hub. Accordingly, it is possible to make a rigidity of the hub in a diametrical direction high, and it is possible to suppress a deformation of the hub due to a restraining force of the recording tape. Since the deformation of the reel is prevented by changing the orientation of the resin, it is possible to reduce a manufacturing cost in comparison with a case that rigidity is increased by insert molding a metal member.

In accordance with a second aspect of the invention, there is provided a reel comprising a hub around which a recording tape is wound, and flanges provided at both end portions of the hub and holding an end portion of the recording tape in a width direction thereof. A flow path of a gate port of a resin molding the hub is inclined in a peripheral direction with respect to an axis of the hub.

It is possible to obtain approximately the same effect as that of the reel in accordance with the first aspect mentioned above, by inclining the flow path of the gate port of the resin molding the hub in the peripheral direction with respect to the axis of the hub.

In accordance with a third aspect of the invention, there is provided a reel comprising a hub around which a recording tape is wound, and flanges provided at both end portions of the hub and holding an end portion of the recording tape in a width direction thereof. The hub is molded by spirally circulating a resin with respect to an axial direction of the hub, and the flange is molded by spirally circulating the resin with respect to a diametrical direction of the flange.

It is possible to make the strength of the hub in the diametrical direction high, and it is possible to suppress the deformation of the hub caused by the restraining force of the recording tape, by making, at a time of molding the hub, the orientation of the resin spiral with respect to the axis of the hub. Further, it is possible to make the strength of the flange in the peripheral direction high, and the rigidity of the flange becomes higher, by making, at a time of molding the flange, the orientation of the resin spiral with respect to the diametrical direction of the flange. Accordingly, it is possible to prevent the reel itself from being deformed. Since the deformation of the reel is prevented by changing the orientation of the resin, it is possible to reduce the manufacturing cost of the reel in comparison with the case that the rigidity is increased by insert molding the metal member.

In accordance with a fourth aspect of the invention, there is provided a reel comprising a hub around which a recording tape is wound, and flanges provided at both end portions of the hub and holding an end portion of the recording tape in a width direction thereof. A groove portion in a peripheral direction with respect to an axis of the hub is formed at an inner peripheral surface of the hub.

In accordance with a fifth aspect of the invention, there is provided a reel comprising a hub around which a recording tape is wound, and flanges provided at both end portions of the hub and holding an end portion of the recording tape in a width direction thereof. A rib inclined in a peripheral direction with respect to an axis of the hub is formed at an inner peripheral surface of the hub.

According to the above fourth and fifth aspects, it is possible to incline the orientation of the resin in the peripheral direction with respect to the axis of the hub at a time of molding the hub, by forming the groove portion or the rib inclined in the peripheral direction with respect to the axis of the hub in the inner peripheral surface of the hub. In particular, it is possible to further improve the strength of the hub by forming the rib in the inner peripheral surface of the hub.

In each of the above aspects of the invention, a reinforcing agent for reinforcing mechanical strength may be added to the resin molding the hub.

A rigidity of the reel becomes higher and strength is increased by adding the reinforcing agent for reinforcing the mechanical strength to the resin molding the hub. Accordingly, it is possible to prevent the reel from being deformed. As the reinforcing agent, there can be listed up a glass fiber, a carbon fiber, talc and the like.

In accordance with a sixth aspect of the invention, there is provided a recording tape cartridge provided with the reel as recited in any one of the aspects mentioned above.

In accordance with a seventh aspect of the invention, there is provided a metal mold for molding a reel having a mold portion for forming a hub around which a recording tape is wound, and a mold portion for forming flanges provided at both end portions of the hub and holding an end portion of the recording tape in a width direction. A flow path to a gate port in which a resin corresponding to a material for the reel flows is inclined in a peripheral direction with respect to an axis of the hub.

In accordance with an eighth aspect of the invention, there is provided a metal mold for molding a reel having a mold portion for forming a hub around which a recording tape is wound, and a mold portion for forming flanges provided at both end portions of the hub and holding an end portion of the recording tape in a width direction. A flow path of a gate port in which a resin corresponding to a material for the reel flows is inclined in a peripheral direction with respect to an axis of the hub.

In accordance with the seventh and eighth aspects mentioned above, since the flow path to the gate port in which the resin flows, or the flow path of the gate port in which the resin flows is inclined in the peripheral direction with respect to the axis of the hub, it is possible to make the orientation of the resin spiral with respect to the axis of the hub at a time of molding the hub. Further, it is possible to make the orientation of the resin spiral with respect to the diametrical direction of the flange at a time of molding the flange.

In accordance with an ninth aspect of the invention, there is provided a method for forming a reel having a hub around which a recording tape is wound and flanges provided at both end portions of the hub and holding an end portion of the recording tape in a width direction. The method comprises molding the hub by spirally circulating a resin with respect to an axial direction of the hub, and molding the flange by spirally circulating the resin with respect to a diametrical direction of the flange.

It is possible to make the strength of the hub in the diametrical direction high and to suppress the deformation of the hub caused by the restraining force of the recording tape, by making, at a time of molding the hub, the orientation of the resin spiral with respect to the axis of the hub. Further, it is possible to make the strength of the flange in the peripheral direction high, and the rigidity of the flange becomes higher, by making, at a time of molding the flange, the orientation of the resin spiral with respect to the diametrical direction of the flange. Accordingly, it is possible to prevent the reel itself from being deformed.

In accordance with each of the aspects of the invention, it is possible to make the strength of the molded hub in the diametrical direction and the strength of the flange in the peripheral direction higher, by inclining the orientation of the resin in the peripheral direction with respect to the axis of the hub at a time of molding the hub and the flange. Thereby, it is possible to prevent the reel itself from being deformed due to the restraining force of the recording tape. Since the deformation of the reel is prevented by changing the orientation of the resin, it is possible to reduce the manufacturing cost in comparison with the case that the rigidity of the reel is increased by insert molding the metal member.

### BRIEF DESCRIPTION OF THE DRAWINGS

Embodiments of the present invention will be described in detail based on the following figures, wherein:

FIG. 1 is an exploded perspective view showing an entire structure of a recording tape cartridge in accordance with an embodiment of the present invention;

FIG. 2 is a schematic cross sectional view showing a reel in accordance with an embodiment of the invention;

FIG. 3 is an explanatory view showing an orientation of a resin in a runner of a hub and a lower flange of the reel in accordance with an embodiment of the invention;

FIG. 4 is an explanatory view showing an orientation of a resin in the hub and the lower flange of the reel in accordance with the embodiment of the invention;

FIG. 5 is a schematic cross sectional view showing a structure of a metal mold for molding the hub and the lower flange of the reel in accordance with an embodiment of the invention;

FIG. 6A is a plan view of a reel showing a modified embodiment of a metal mold molding the hub of the reel in accordance with the embodiment of the invention;

FIG. 6B is a schematic cross sectional view showing the modified embodiment of the structure of the metal mold and the lower flange;

FIG. 7 is a perspective view showing the other modified embodiment of the reel in accordance with the embodiment of the invention; and

FIG. 8 is an explanatory view showing a deformed state of a conventional reel.

### DETAILED DESCRIPTION OF THE INVENTION

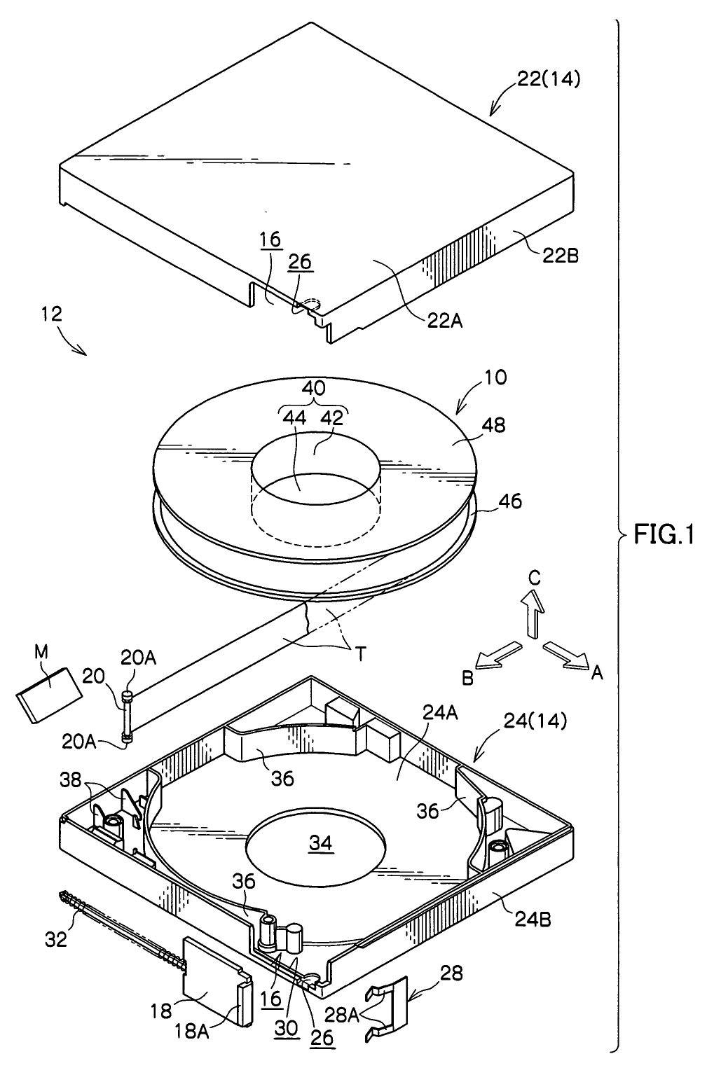

A description will be given of a reel 10 in accordance with an embodiment of the invention with reference to FIGS. 1 to 4.

A reel 10 pertaining to an embodiment of the present invention will be described on the basis of FIG. 1 to FIG. 4. First, the overall configuration of a recording tape cartridge 12 to which the reel 10 is applied will be described, and then the reel 10 will be described in detail. For the sake of convenience, the direction indicated by arrow A, which is a direction in which the recording tape cartridge 12 is loaded into a drive device, will be referred to as the front direction (front side), the direction indicated by arrow B, which is orthogonal to the direction of arrow A, will be referred to as the right direction, and the direction indicated by arrow C, which is orthogonal to the direction of arrow A, will be referred to as the up direction.

(Configuration of the Recording Tape Cartridge)

FIG. 1 shows an exploded perspective view of the recording tape cartridge 12. The recording tape cartridge 12 includes a case 14 that is substantially rectangular in plan view. A single reel 10, onto which magnetic tape T serving as an information recording and playback medium (recording tape) is wound, is rotatably housed inside the case 14.

An opening 16 for pulling the magnetic tape T outside the case 14 is disposed in a front-direction end portion of a right side wall of the case 14. The opening 16 is configured such that it is closed off by a door 18 when the recording tape cartridge 12 (the magnetic tape T) is not in use and is opened inside the drive device when the recording tape cartridge 12 is in use.

Further, a leader pin 20 that is a leader member is attached to the leading end of the magnetic tape T. The leader pin 20 is formed in a small circular column-like shape and includes flange portions 20A that are disposed on both longitudinal-direction ends of the leader pin 20 and protrude further upward and downward than the width-direction end portions of the magnetic tape T. When the recording tape cartridge 12 is in use, the flange portions 20A become caught on a pullout member of the drive device such that the magnetic tape is pulled out from the case 14.

The case 14 is configured as a result of an upper case 22 and a lower case 24 being joined together. The upper case 22 is configured by a top plate 22A, which is substantially rectangular in plan view, and a substantially frame-like peripheral wall 22B, which stands along the outer edge of the top plate 22A. The lower case 24 is configured by a bottom plate 24A, which has a shape substantially corresponding to the shape of the top plate 22A, and a peripheral wall 24B, which stands along the outer edge of the bottom plate 24A. Additionally, the case 14 is formed in a substantial box-like shape as a result of the upper case 22 and the lower case 24 being joined together, by ultrasonic welding or with screws, in a state where the open end of the peripheral wall 22B and the open end of the peripheral wall 24B have been brought into contact with each other.

The opening 16 is formed in a substantially rectangular shape in side view and opens rightward (in the direction of arrow B) at the front-direction end portion of a right side wall 14B (right side wall of the case 14 configured by the peripheral wall 22B and the peripheral wall 24B) of the case 14, the right side wall 14b is positioned along the direction of arrow A. Pin receiving recess portions 26 that accommodate the flange portions 20A of the leader pin 20 are disposed in the top plate 22A and the bottom plate 24A. Each of the pin receiving recess portions 26 opens rightward in the vicinity of the front end of the opening 16 and enables the leader pin 20 to enter and exit the case 14 through the opening 16.

Further, a plate spring 28 is attached in the vicinity of the front end of the case 14, and upper and lower arms 28A are disposed on the plate spring 28. The plate spring 28 causes the leading ends of the arms 28A to engage with the flange portions 20A of the leader pin 20 and retain the leader pin 20 with respect to the case 14. The leader pin 20 is released from this retained state as a result of being pulled in the right direction with a force equal to or greater than a predetermined value.

The door 18 that opens and closes the opening 16 is formed in a substantially rectangular tabular shape that can close off the opening 16 by itself. The upper and lower end portions of the door 18 slidably enter guide grooves 30 that are disposed in the top plate 22A and the bottom plate 24A and are formed along the open surface of the opening 16 and the right side wall 14B.

Thus, the door 18 is configured to be selectively movable between a closed position where the door 18 closes off the opening 16 and an open position where the door 18 opens the opening 16 as a result of the door 18 sliding in the front and rear directions while being guided in the guide grooves 30. Additionally, the door 18 is biased in the front direction by a coil spring 32 that is a biasing member disposed between the door 18 and the case 14, and is ordinarily positioned in the closed position by the biasing force of the coil spring 32. An operational portion 18A is disposed on the front-direction end portion of the door 18 and protrudes in the right direction. The door 18 can be moved to the open position counter to the biasing force of the coil spring 32 by pushing the operational portion 18A rearward.

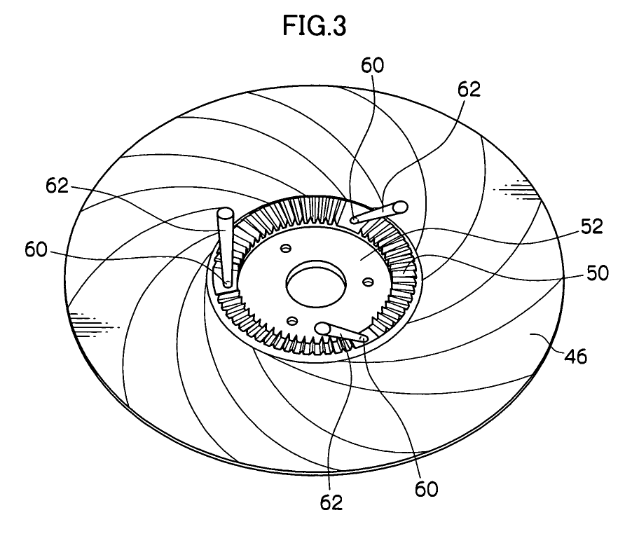

Further, a gear opening 34 for exposing a later-described reel gear 50 (see FIG. 3) of the reel 10 is disposed in the central portion of the bottom plate 24A of the case 14. When the recording tape cartridge 12 is in use, the reel 10 is rotatably driven, in a state of non-contact inside the case 14, when a drive gear of the drive device meshes with the reel gear 50 and rotates.

Moreover, the case 14 includes guidance regulation walls 36 that sectionally stand from the top plate 22A and the bottom plate 24A along a circumference coaxial with the gear opening 34 and are configured as a result of their upper and lower ends being brought into contact with each other. The guidance regulation walls 36 suppress chattering of the reel 10. End portions of the guidance regulation walls 36 are continuous with the peripheral walls 22B and 24B, and the guidance regulation walls 36 prevent dust and the like from ingressing into the region where the reel 10 is disposed.

Further, a memory board M, in which various information for each recording tape cartridge 12 is stored, is disposed in the right side rear corner portion inside the case 14. The memory board M is supported by a pair of support ribs 38 such that the memory board M slants substantially 45° with respect to the bottom plate 24A, in order to enable communication with the drive device that communicates from the underside and a library device that communicates from the rear side. That is, the support ribs 38 are configured such that their upper edges, which are the surfaces that support the memory board M, slant a predetermined angle (in the present embodiment, 45°).

(Structure of Reel)

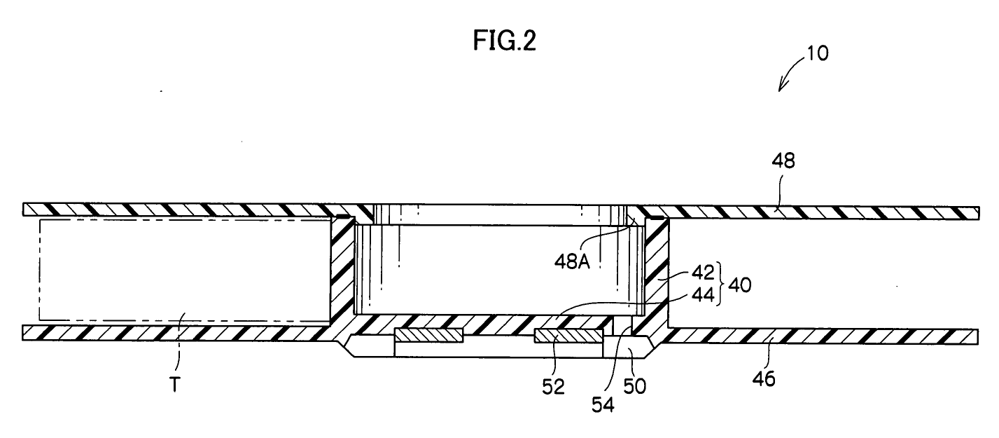

FIG. 2 shows a cross sectional view of the reel 10. The reel 10 is molded by a resin (for example, a polycarbonate containing 10% glass reinforcing fiber), and is provided with an approximately cylindrical hub 40 constituting a shaft center portion. The hub 40 has a cylinder portion 42 in which a magnetic tape T is wound around an outer peripheral surface, and a bottom portion 44 (one end portion of the hub 40) closing a lower portion of the cylinder portion 42.

Further, a lower flange 46 is integrally formed in an outer periphery of the bottom portion 44 of the hub 40, and axially protrudes toward an outer side in a diametrical direction. On the other hand, an upper side of the hub 40 is open, and an upper flange 48 having the same outer diameter as an outer diameter of the lower flange 46 is coaxially bonded to an upper end portion of the hub 40 in accordance with an ultrasonic welding or the like.

A short tube portion 48A inside fitted to the cylinder portion 42 is formed in a shaft center portion of the upper flange 48, and is ultrasonic welded to an upper end surface of the cylinder portion 42 in a state in which the short tube portion 48A is inside fitted to the cylinder portion 42. The reel 10 is structured such that a magnetic tape T is wound around the outer peripheral surface of the cylinder portion 42 (the hub 40) between the lower flange 46 and the upper flange 48. Further, the lower flange 46 and the upper flange 48 is structured such as to regulate a displacement in a width direction of the magnetic tape T wound around the hub 40 (an axial direction of the hub 40).

The reel gear 50, which is annularly formed, is disposed in the vicinity of the outer periphery of the outer surface (undersurface) of the bottom portion 44 of the hub 40 as shown in FIG. 3. When the recording tape cartridge 12 is in use, the reel gear 50 is exposed through the gear opening 34 of the case 14 and relatively moves along the axial line direction with respect to a rotating shaft of the drive device, whereby the reel gear 50 meshes with, and disengages from, the drive gear disposed on a leading end of the rotating shaft.

Further, a reel plate 52 comprising magnetic material is integrally disposed, by insert molding, on the radial-direction inner side of the reel gear 50 in the undersurface of the bottom portion 44. The reel plate 52 is configured such that it is attracted and retained without contact by a magnet disposed on the leading end of the rotating shaft of the drive device.

Moreover, an unillustrated lock mechanism for inhibiting the rotation of the reel 10 when the magnetic tape T is not in use is disposed at the inner side of the hub 40. The lock mechanism includes a lock member that does not rotate with respect to the case, and supports the lock member such that the lock member is movable toward and away from the bottom portion 44 of the reel 10. Further, the lock member is configured to be movable, as a result of moving toward and away from the bottom portion 44, between a rotation lock position where the lock member engages with an engagement portion (not shown) of the bottom portion 44 and inhibits the rotation of the reel 10 with respect to the case 14 and a release position where the lock member disengages from the engagement portion and allows the rotation of the reel 10.

For this reason, the engagement portion with which the lock member engages is disposed in the bottom portion 44, and an operational hole 54 is formed in the bottom portion 44 for a lock release member of the drive device to operate the lock member from the outside. In the present embodiment, a configuration is shown where the operational hole 54 is disposed in the site where the reel gear 50 is formed, but the operational hole 54 may also be disposed in the axial center portion of the bottom portion 44, for example.

As described above, the bottom portion 44 of the hub 40 is configured to fulfill the function that rotational force is transmitted from the drive device with the reel gear 50 formed, the function of closing off the gear opening 34 of the case 14 when the recording tape cartridge 12 is not in use, and the function of causing the lock member to engage and inhibit the rotation of the reel 10 with respect to the case 14.

The hub 40, whose bottom portion 44 that fulfills various functions in this manner closes off the lower end of the triangular cylinder 42 (protrudes inward in the radial direction from the lower end), is configured such that its lower end side is stronger (more rigid) with respect to the winding pressure of the magnetic tape T than its upper end side, which is the open end, as a result of the reinforcing effect of the bottom portion 44.

Next, the action of the embodiment of the present invention will be described.

When the recording tape cartridge 12 is loaded into the drive device in order to record information on the magnetic tape T or play back information recorded on the magnetic tape T, the rotational lock on the reel 10 with respect to the case 14 is released, the rotating shaft (drive gear) of the drive device meshes with the reel gear 50 of the reel 10, and the reel 10 rotates inside the case 14 as a result of the rotating shaft rotation.

At this time, the leader pin 20 that has already been taken out through the opening 16 is retained on the take-up reel of the drive device, and the take-up reel rotates in synchronization with the reel 10, whereby the magnetic tape T is sequentially pulled out from the case 14. Then, a recording and playback head disposed along a predetermined tape path writes information on the magnetic tape T or reads information recorded on the magnetic tape T. After the magnetic tape T has been used, the reel 10 returns the magnetic tape T to its initial wound state.

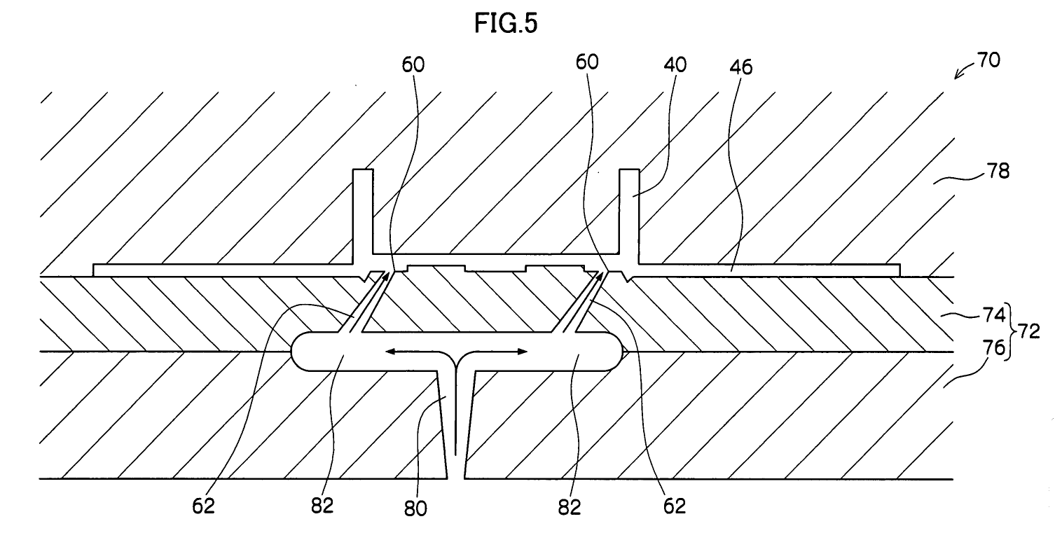

In the manufacture of the reel 10, as shown in FIGS. 3 and 5, (FIG. 5 illustrates a metal mold 70 molding the hub 40 and the lower flange 46), a part of a portion corresponding to a reel gear 50 formed in the bottom portion 44 side of the hub 40 is divided in the metal mold 70 (in this case, into three sections), and gate ports (a so-called gate position, respectively) 60 are formed at the portions. A flow path 62 (hereinafter, refer to “runner 62”) to the gate port 60 is formed in a direction inclined in a peripheral direction with respect to an axis of the hub 40. The runner 62 is formed as a so-called undercut with respect to a mold 74.

In the metal mold 70, a fixed side metal mold 72 (a so-called cavity side) is structured as a two-layer structure comprising a mold 74 and a mold 76. After molding the lower flange 46 and the hub 40, the runner 62 is forcibly drawn and released from the mold 74 by moving the mold 74 at the time of, or after, moving a movable side metal mold 78. A sprue 80 and a runner 82 are released from the mold 76 by an unloading machine (not shown). On the other hand, the lower flange 46 and the hub 40 are released from the movable side metal mold 78 by an ejector pin (not shown) or the like.

In this embodiment, the fixed side metal mold 72 is structured by two layers, and the runner 62 is structured such as to be released from the mold 74 by forcible drawing therefrom. However, since it is enough that the runner 62, which is inclined in a peripheral direction with respect to the axis of the hub 40, can be released from the fixed side metal mold 72, the mold structure is not limited to the configuration mentioned above.

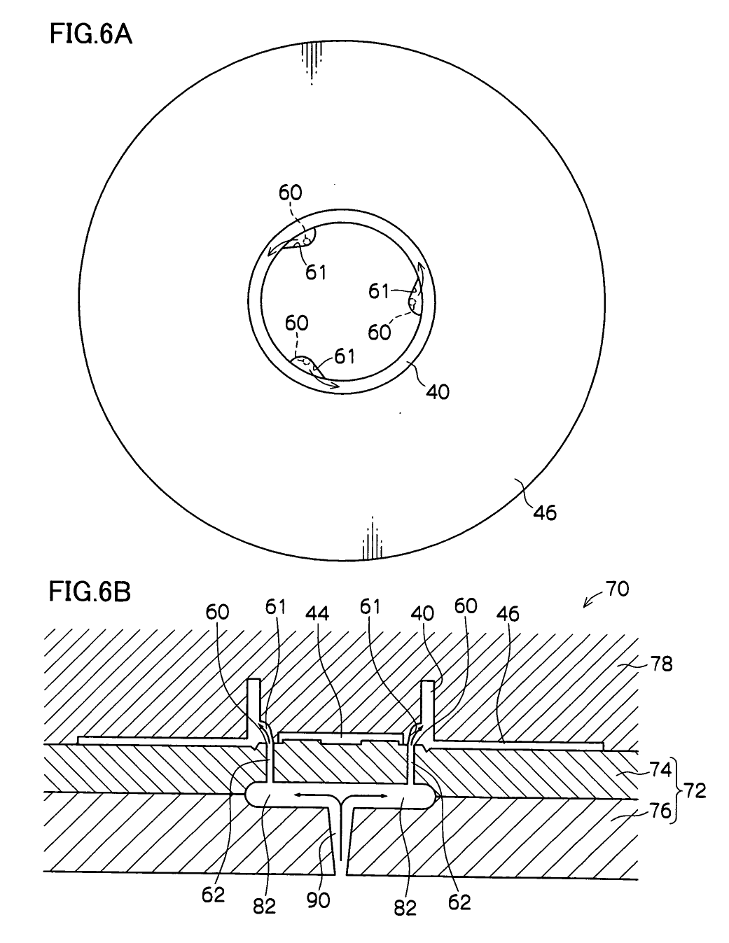

For example, as shown in FIG. 6B, the mold structure may be made such that the runner 62 is formed along the moving direction of the mold 74, and the flow path 61 of the gate port 60 is inclined in a peripheral direction with respect to the axis of the hub 40. In this case, the flow path 61 may be formed to have a portion protruding corresponding to the gate port 60, that is provided at a portion corresponding to the upper surface of the bottom portion 44 of the hub 40, and may be provided so as to be connected to a portion corresponding to the hub 40. In accordance with this structure, the resin flows into the portion corresponding to the hub 40 while maintaining the inflow angle at which the resin flows to the flow path 61 from the gate port 60.

Further, the mold structure may be made, as shown in FIG. 6A, such that the flow path 61 is inclined in the peripheral direction with respect to the axis of the hub 40 in a cross sectional view, and is formed in an approximately teardrop shape in a plan view, and the resin flowing from the gate port 60 is guided along the direction of the arrow to the hub 40 from the flow path 61.

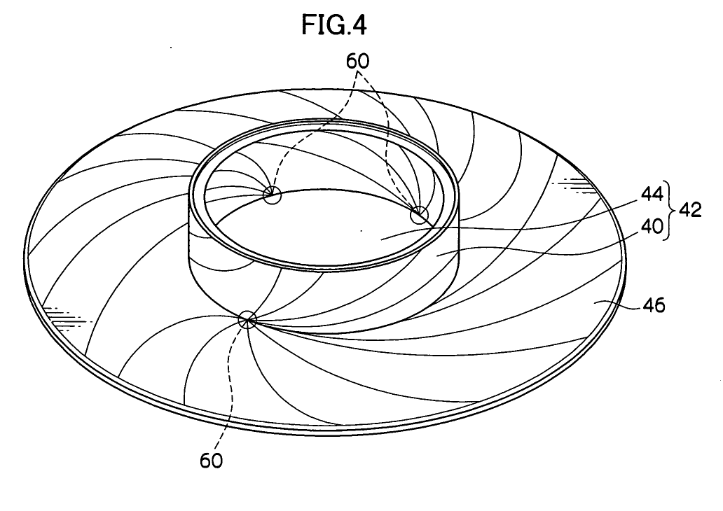

In accordance with the structure mentioned above, the resin flowing from the gate port 90 is guided along the flow path 62, and in the hub 40, it is possible to incline the orientation of the resin (the flow of the resin) in the peripheral direction with respect to the axis of the hub 40, as shown in FIG. 4. Further, in the lower flange 46, it is possible to incline the orientation of the resin with respect to a direction of a radial line of the lower flange 46 (in a spiral shape in a plan view).

In other words, in comparison with the case that the orientation of the resin is formed along the axial direction of the hub 40, it is possible to make a strength of the hub 40 in the diametrical direction higher, and it is possible to suppress the deformation of the hub 40 caused by the restraining force of the magnetic tape T. Further, in the lower flange 46, in comparison with the case that the orientation of the resin is formed along the direction of the radial line of the lower flange 46, it is possible to make the strength of the lower flange 46 in the peripheral direction higher. Accordingly, the rigidity of the lower flange 46 becomes higher, and it is possible to prevent the reel 10 itself from being deformed.

Since it is possible to prevent the reel 10 from being deformed only by changing the orientation of the resin, it is possible to lower the manufacturing cost in comparison with the case that the rigidity is increased by insert molding the metal member. Further, in the present embodiment, since the reel 10 is formed by the resin containing the glass reinforcing fiber, the rigidity of the reel 10 becomes further higher, and the strength is increased.

The molding is configured, as shown in FIG. 3, such that the orientation of the resin is inclined in the peripheral direction with respect to the axis of the hub 40, by inclining the flow path 62 to the gate port 60 of the resin in the peripheral direction with respect to the axis of the hub 40, however, the molding configuration is not limited to this as far as the orientation of the resin can be inclined in the peripheral direction with respect to the axis of the hub 40.

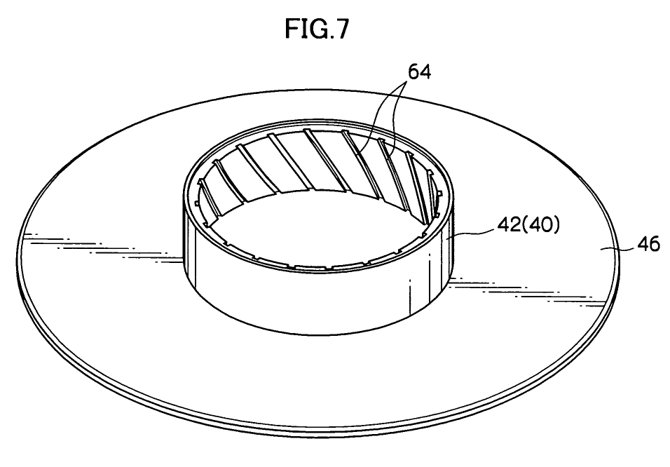

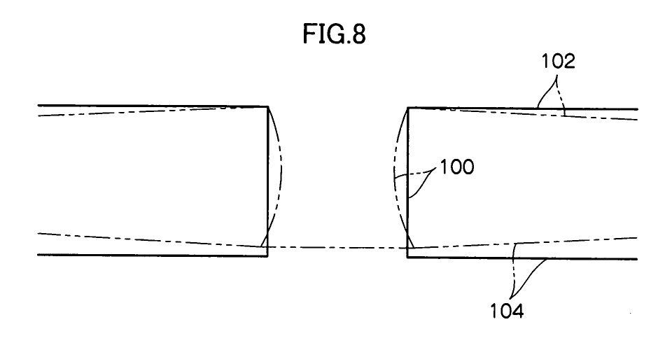

For example, as shown in FIG. 7, a plurality of groove portions 64 inclined in the peripheral direction with respect to the axis of the hub 40 may be formed at an inner surface side of the hub 40. In accordance with this structure, the orientation of the flowing resin is along the metal mold corresponding to the groove portion 64 at a time of molding the hub 40. Alternately, although an illustration is omitted, ribs may be formed in places of the groove portions 64 at the inner peripheral surface of the hub 40. In this case, it is possible to further improve the strength of the hub 40. Further, the structure may be made such that the groove portions 64 or the ribs are formed at the inner surface side of the hub 40 and the flow path 62 to the gate port 60 is inclined in the peripheral direction with respect to the axis of the hub 40.

In the present embodiment, the reel 10 is molded by the polycarbonate containing the glass reinforcing fiber, however, a carbon fiber or talc may be added to the polycarbonate for reinforcing the mechanical strength of the reel 10.

In each of the embodiments mentioned above, there is shown the example in which the lower flange 46 is integrally formed with the hub 40, however, the invention is not limited to this, but the lower flange 46 formed as an independent body from the hub 40 is firmly attached to the lower end portion of the hub 40.

Further, in each of the embodiments mentioned above, there is shown the example in which the single reel 10 is accommodated within the recording taper cartridge 12, however, the invention is not limited to this, but two reels 10 may be accommodated within the two-reel type recording taper cartridge.

What is claimed is:

1. A reel comprising:
a hub around which a recording tape is wound; and
flanges provided at both end portions of the hub and holding an end portion of the recording tape in a width direction thereof,
wherein a flow path to a gate port for a resin molding the hub is inclined in a peripheral direction with respect to an axis of the hub.

2. A reel comprising:
a hub around which a recording tape is wound; and
flanges provided at both end portions of the hub and holding an end portion of the recording tape in a width direction thereof,
wherein a flow path of a gate port for a resin molding the hub is inclined in a peripheral direction with respect to an axis of the hub.

3. A reel comprising:
a hub around which a recording tape is wound; and
flanges provided at both end portions of the hub and holding an end portion of the recording tape in a width direction,
wherein the hub is molded by spirally circulating a resin with respect to an axial direction of the hub, and the flange is molded by spirally circulating the resin with respect to a diametrical direction of the flange.

4. A reel comprising:
a hub around which a recording tape is wound; and
flanges provided at both end portions of the hub and holding an end portion of the recording tape in a width direction,
wherein the hub has a groove portion inclined in one peripheral direction with respect to an axis of the hub at an inner peripheral surface thereof

5. A reel comprising:
a hub around which a recording tape is wound; and
flanges provided at both end portions of the hub and holding an end portion of the recording tape in a width direction,
wherein the hub has a rib inclined in one peripheral direction with respect to an axis of the hub at an inner peripheral surface thereof.

6. The reel as claimed in claim 1, wherein a reinforcing agent for reinforcing mechanical strength is added to the resin molding the hub.

7. A recording tape cartridge provided with the reel as claimed in claim 1.

8. A recording tape cartridge provided with the reel as claimed in claim 2.

9. A recording tape cartridge provided with the reel as claimed in claim 3.

10. A recording tape cartridge provided with the reel as claimed in claim 4.

11. A recording tape cartridge provided with the reel as claimed in claim 5.

12. A metal mold for molding a reel comprising:
a mold portion for molding a hub around which a recording tape is wound; and
a mold portion for molding flanges provided at both end portions of the hub and holding an end portion of the recording tape in a width direction,
wherein a flow path to a gate port, in which a resin corresponding to a material of the reel flows, is inclined in a peripheral direction with respect to an axis of the hub.

13. A metal mold for molding a reel comprising:
a mold portion for molding a hub around which a recording tape is wound; and
a mold portion for molding flanges provided at both end portions of the hub and holding an end portion of the recording tape in a width direction,
wherein a flow path of a gate port, in which a resin corresponding to a material of the reel flows, is inclined in a peripheral direction with respect to an axis of the hub.

14. A method for forming a reel having a hub around which a recording tape is wound and flanges provided at both end portions of the hub and holding an end portion of the recording tape in a width direction comprising:
molding the hub by spirally circulating a resin with respect to an axial direction of the hub; and
molding the flange by spirally circulating the resin with respect to a diametrical direction of the flange.
